(19) United States
(12) Patent Application Publication
(10) Pub. No.: US 2026/0235471 A1
(43) Pub. Date: Aug. 13, 2026

(54) SIGNAL PROCESSING METHOD IN PHASE OTDR

(71) Applicant: NTT, Inc., Tokyo (JP)

(72) Inventors: Yoshifumi WAKISAKA, Musashino-shi, Tokyo (JP); Hiroshi TAKAHASHI, Musashino-shi, Tokyo (JP); Daisuke IIDA, Musashino-shi, Tokyo (JP); Takahiro ISHIMARU, Musashino-shi, Tokyo (JP); Yusuke KOSHIKIYA, Musashino-shi, Tokyo (JP)

(73) Assignee: NTT, Inc., Tokyo (JP)

(21) Appl. No.: 19/154,359

(22) PCT Filed: Feb. 9, 2023
(86) PCT No.: PCT/JP2023/004382

§ 371 Date: Aug. 6, 2025

(51) Int. Cl. G01M 11/00

(52) U.S. Cl. CPC G01M 11/3145

(57) ABSTRACT

According to present disclosure, there is provided a signal processing device as a phase OTDR that performs processing of averaging scattered light vector signals pertaining to a plurality of optical frequencies different from each other, by an optical frequency multiplexing technique, the signal processing device including: a functional unit that calculates a correction value for a phase offset between different optical frequencies per measurement data within a range of a time window having a predetermined window length; and a functional unit that executes correction for the phase offset the between different optical frequencies by performing processing of averaging measurement data, belonging to a middle of the time window and a timing later than the middle, by using the correction value with the time window kept moving in a time direction.

### TECHNICAL FIELD

The present invention relates to a phase optical time-domain reflectometer (OTDR) for measuring a phase of scattered light from each point of a measurement target optical fiber.

### BACKGROUND ART

As means for measuring a physical vibration applied to an optical fiber in a distributed manner in a longitudinal direction of the optical fiber, there is a known method called distributed acoustic sensing (DAS), in which pulsed test light enters a measurement target optical fiber and backscattered light generated by Rayleigh scattering is detected (Non Patent Literature 1).

There is DAS-phase (DAS-P) that is a method of measuring a phase of scattered light from each point of a measurement target optical fiber and observing temporal changes in the phase. In DAS-P, a phase linearly changes in response to a change in the optical path length of an optical fiber due to vibration, and a change rate in the phase at separate points of the optical fiber can be also regarded as being approximately the same with respect to the longitudinal direction thereof. Thus, vibration can be quantitatively measured, and a waveform of vibration applied to the measurement target optical fiber can be faithfully reproduced (for example, Non Patent Literature 2).

In the DAS-P using light pulses having a single optical frequency, a point where an intensity of the scattered light is low occurs due to an interference effect between pieces of scattered light within a pulse width, and sensitivity is deteriorated. As a method of preventing deterioration in sensitivity, there is a method of performing optical frequency multiplexing and averaging signals at different optical frequencies (Patent Literature 1). Hereinafter, the method disclosed in Patent Literature 1 is referred to as a technique in the related art. The technique in the related art utilizes a fact that a point where an intensity of the scattered light decreases changes at different optical frequencies.

In the technique in the related art, the following procedure is specifically performed as an efficient averaging method.

Procedure S01: A difference in a phase offset value between a scattered light vector pertaining to an optical frequency component selected, as a reference, from multiplexed optical frequency components and a scattered light vector having another optical frequency component is calculated using measurement data at a plurality of timings. A rotation angle for correcting a phase offset of each frequency is calculated using the calculated difference in the phase offset value.

Procedure S02: A frequency average vector is calculated by rotating each frequency vector at each timing by the rotation angle and then averaging the rotated vectors pertaining to different frequencies. An angular change of the frequency average vector is calculated.

Procedure S03: A phase difference between two points separated by a gauge length is calculated using the angular change, and phase connection processing or the like is performed. Thus, a vibration waveform is calculated.

In particular, details of the procedure S01 are performed as the following specific procedures. Here, a sampling interval of vibration is set to t, and measurement data belonging to M points from a measurement timing 0 to a measurement timing (M−1)t (M is a natural number) are used. Further, scattered light vectors pertaining to the reference optical frequency (set to f₁), present at the different timings mt (m is an integer from 0 to (M−1)), are set to r₁(mt, z) (depending on the optical fiber point and thus depending on a distance z from an inject end), and scattered light vectors pertaining to each optical frequency f₁ of the rest (i is an integer from 2 to N, and N represents the number of frequencies subject to multiplexing) are set to rᵢ(mt, z).

Procedure S01-1: Angles θ₁(mt, z) of the scattered light vectors r₁(mt, z) pertaining to the reference optical frequency, present at the different timings and at each optical fiber point, are calculated. Assuming that the scattered light vectors r₁(mt, z) are complex vectors on a complex plane, that is, complex numbers, the angles θ₁(mt, z) can be calculated by arg[r₁(mt, z)]. Here, arg is an operator that gives an argument of a complex number.

Procedure S01-2: r_{i_rot}(mz, t) are set by rotating the scattered light vectors rᵢ(mt, z) pertaining to each optical frequency, present at the different timings and at each optical fiber point, by angles −θ₁(mt, z). Assuming that the scattered light vectors rᵢ(mt, z) are complex vectors on a complex plane, the rotated vectors r_{i_rot}(mz, t) can be calculated as exp [−θ₁(mt, z)]×rᵢ(mt, z).

Procedure S01-3: The vectors r_{i_rot}(mt, z) obtained by rotating the scattered light vectors pertaining to each optical frequency, present at each optical fiber point, are averaged, and a time average vector r_{i_avet}(z) is calculated: since m, as adopted measurement data, is 0 to (M−1), the number of vectors subject to average is M. In actual calculation, a vector sum may be used instead of averaging the M vectors. In either method, the same result is obtained in subsequent processing.

Procedure S01-4: −arg[r_{i_avet}(z)] is calculated by using, as the argument of the time average vector, a rotation angle αᵢ(z) by which the scattered light vector pertaining to each optical frequency, present at each optical fiber point, is rotated in the procedure S02. Since a value of +arg[r_{i_avet}(z)] is a difference in the phase offset value, the difference in the phase offset can be corrected by rotation by −arg[r_{i_avet}(z)].

The rotation angle αᵢ(z) given in the procedure S01-4 is a value in which noise is efficiently reduced because time averaging is performed in accordance with the procedure S01 to the procedure S03. Therefore, by calculating the optical frequency average vector in the procedure S02 using the rotation angle αᵢ(z), an SN ratio of a final vibration waveform can be improved, and waveform distortion can be prevented.

In the procedure S01 of the technique in the related art, the rotation angle pertaining to each optical frequency is calculated using measurement data belonging to M points corresponding to the measurement timings from 0 to (M−1)t (M is a natural number). Further, in the procedure S02, frequency averaging is performed on the measurement data belonging to the M points corresponding to the measurement timings from 0 to (M−1)t (M is a natural number) and measurement data belonging to other timings by using the calculated rotation angle.

An optimum value of the rotation angle, calculated by the method using the procedure S01 of the technique in the related art, changes with time due to a temporal change in optical characteristics such as an oscillation frequency of a laser, a temperature change of a measurement target optical fiber itself, application of a large dynamic strain to the measurement target optical fiber, or the like. Therefore, distributed vibration measurement over a long period of time requires that the optimum value of the rotation angle be continuously updated, and processing subsequent to the procedure S02 be performed. However, the technique in the related art as disclosed in Patent Literature 1 does not disclose a method of performing the procedure S02 and the processing subsequent thereto with the optimum value of the rotation angle continuously updated. Further, when frequency averaging is performed on the pieces of measurement data used for calculating the rotation angle, by using the calculated rotation angle, the data cannot be streamed, and the measurement data needs to be held in a memory of a calculator until completion of the frequency averaging.

A solution to this problem has been proposed in a prior application technique (PCT/JP2022/34477). In the prior application technique, the processing subsequent to the procedure S02 is performed with the optimum value of the rotation angle continuously updated. Using the prior application technique can cope with a change in the optimum value of the rotation angle and enable data streaming processing. Further, measurement data does not need to be held in a memory of a computer until completion of the frequency averaging.

Even in the prior application technique, as in the technique in the related art, a rotation angle αᵢ(z) pertaining to each optical frequency fᵢ is calculated from the scattered light vector rᵢ(kt, z). However, unlike the technique in the related art, in the prior application technique, the measurement data are divided into blocks, the number of which is the number of time points M, and the rotation angle is calculated and updated per block of the measurement time Mt.

That is, assuming that k=0 is set as a first point of measurement data and calculation of the rotation angle is started from the first point, for example, measurement data of the scattered light vectors rᵢ(kt, z) in which k is 0 to M−1 are included in a first block, and measurement data of the scattered light vectors rᵢ(kt, z) in which k is M to 2M−1 are included in a second block. K is used as a symbol of a number for distinguishing the blocks. For example, in the above example, a block in which k is 0 to M−1 is a block of K=1, and a block in which k is M to 2M−1 is a block of K=2. The K-th block includes measurement data in which k is M(K−1) to MK−1. Since the rotation angle is calculated per block, the value of the rotation angle changes in response to the block K. Thus, the rotation angle is denoted as αᵢ(z, K). The calculation method of the rotation angle in each of the blocks is performed in a similar manner to the procedure S01 of the technique in the related art.

In the prior application technique, since the rotation angle is calculated and updated per block, the value of the rotation angle discontinuously changes per movement to the adjacent block. For this reason, when a temperature state or a strain state of the optical fiber greatly changes due to the measurement over a long time, a phenomenon in which the final vibration waveform also discontinuously changes is observed between the measurement data points corresponding to a transition between the adjacent blocks is performed. For example, a phenomenon in which the vibration waveform discontinuously changes between a timing (MK−1)t, i.e. the last measurement data point of the block K, and a timing MKt, i.e. the first measurement data point of the block K+1, occurs.

### CITATION LIST

### Patent Literature

Patent Literature 1: JP 2020-169904 A (NTT, Registered Patent)

### Non Patent Literature

Non Patent Literature 1: Ali. Masoudi, T. P. Newson, “Contributed Review: Distributed optical fibre dynamic strain sensing.” Review of Scientific Instruments, vol. 87, p. 011501 (2016)
Non Patent Literature 2: Ken'ichi Nishiguchi, Che-Hsien Li, Artur Guzik, Mitsunori Yokoyama, Kinzo Kishida, “Fabrication of Fiber-Optic Distributed Acoustic Sensor and Its Signal Processing”, IEICE Technical Report, 115 (202), pp. 29-34 (2015)
Non Patent Literature 3: Yoshifumi Wakisaka, Daisuke Iida, Hiroyuki Oshida, and Nazuki Honda, “Fading Suppression of Φ-OTDR With the New Signal Processing Methodology of Complex Vectors Across Time and Frequency Domains,” J. Lightwave Technol. 39, 4279-4293 (2021)

### SUMMARY OF INVENTION

### Technical Problem

An object of the present invention is to prevent a deterioration in an SN ratio and vibration measurement accuracy and to resolve a discontinuous change in a vibration waveform even in a situation where a temperature state or a strain state of an optical fiber largely changes.

### Solution to Problem

In the present invention, in order to remove a discontinuous change in a rotation angle used for averaging different frequency vectors, a window length Mt (M is a natural number and corresponds to the number of data points) used for signal processing is set in advance, a rotation angle is calculated using measurement data included in the window with the window kept moving, and averaging of frequency vectors at the middle of the window or at timings after the middle of the window, which correspond to a preset quantity of measurement data is performed by using the rotation angle. Calculating the rotation angle with the window kept moving is moving averaging in a broad sense. Thereby, the calculating can bring about the rotation angle that does not include discontinuous change and smoothly changes. By using the rotation angle that smoothly changes, discontinuous change in the vibration waveform can be removed.

Specifically, according to the present invention, there are provided a signal processing device as a phase OTDR and a signal processing method for a phase OTDR that perform processing of averaging scattered light vector signals pertaining to a plurality of optical frequencies different from each other, by an optical frequency multiplexing technique.

The signal processing device (method) includes:
a functional unit that calculates (a procedure of calculating) a correction value for a phase offset between different optical frequencies per measurement data within a range of a time window having a predetermined window length; and
a functional unit that executes (a procedure of executing) correction for the phase offset between the different optical frequencies by performing processing of averaging measurement data, belonging to a middle of the time window and a timing later than the middle, by using the correction value with the time window kept moving in a time direction.

The functional unit that calculates the correction value may be configured to: acquire measurement data of scattered light deriving from a plurality of light pulses having different optical frequencies, which are scattered in an optical fiber; calculate scattered light vectors rᵢ of the scattered light pertaining to each optical frequency within the time window having the predetermined window length; perform averaging of the scattered light vectors rᵢ of the optical frequencies included in the time window; and calculate a rotation angle αᵢ for correcting a phase of each optical frequency by using a time average vector r_{i_avet} obtained by the averaging.

The functional unit that performs the correction may be configured to correct the phase offset between the different optical frequencies by rotating a phase of a scattered light vector rᵢ pertaining to each optical frequency by a rotation angle αᵢ and calculating a frequency-averaged vector from each rotated vector Rᵢ belonging to the middle of the time window and the timing later than the middle.

According to the present invention, there are provided a program for directing a computer to implement each function of the signal processing device according to the present invention, and a program for directing a computer to execute each procedure included in the signal processing method performed by the signal processing device according to the present invention.

Note that the above inventions can be combined in any possible manner.

### Advantageous Effects of Invention

According to the present invention, data streaming processing can be performed, and a deterioration in an SN ratio and vibration measurement accuracy can be prevented even in measurement for a long time. Further, according to the present invention, because a discontinuous change in a vibration waveform, which is a problem of the prior application technique, is removable, measurement with high accuracy can be performed even in a situation where a temperature state or a strain state of an optical fiber largely changes.

### BRIEF DESCRIPTION OF DRAWINGS

FIG. 1 illustrates a configuration example of a processing unit in a prior application technique.

FIG. 2 illustrates a processing procedure in a prior application technique.

FIG. 3 illustrates a configuration example of a measurement device according to the present invention.

FIG. 4 is a flowchart illustrating an example of a signal processing method according to the present invention.

### DESCRIPTION OF EMBODIMENTS

Hereinafter, an embodiment of the present disclosure will be described in detail with reference to the drawings. Note that the present disclosure is not limited to the embodiments described below. These embodiments are merely examples, and the present disclosure can be implemented in a form with various modifications and improvements based on the knowledge of those skilled in the art. Note that components denoted by the same reference numerals in the present specification and the drawings are the same components.

### (Processing of Prior Application Technique)

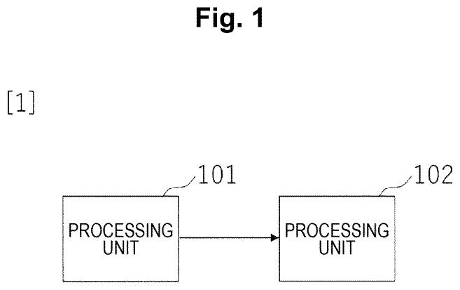

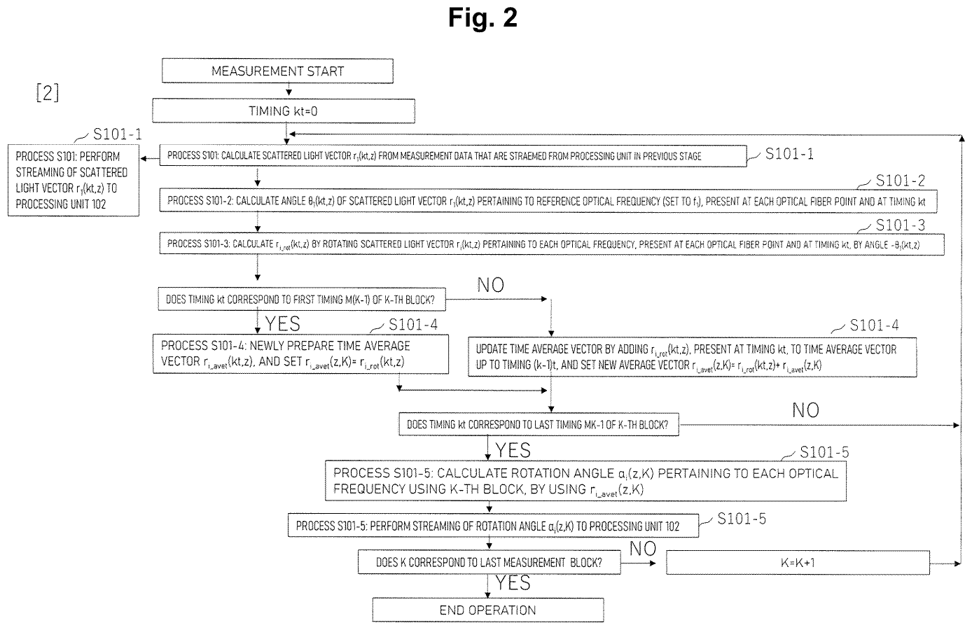

In FIG. 1, a key point of the prior application technique, with regard to signal processing of measurement data in a K-th block, will be described below. The key point is based on the premise that a processing unit 101 and a processing unit 102 as illustrated in FIG. 1 perform a key point operation. A flowchart of the processing unit 101 is illustrated in FIG. 2. On starting measurement, measurement data, obtained by processing in a preceding stage by the processing unit 101, is transmitted to the processing unit 101.

Process S101-1: A scattered light vector rᵢ(kt, z) is calculated.

Process S101-2: A reference frequency is set to f₁. Here, the reference frequency can be freely selected, and thus the reference frequency may not be f₁. An angle θ₁(kt, z) of a scattered light vector r₁(kt, z) pertaining to the reference optical frequency, present at each optical fiber point and at a timing kt is calculated. For example, the angle θ₁(kt, z) is calculated as follows.

$${θ}_{1} ( kt , z ) = arg [ {r}_{1} ( kt , z ) ] \qquad ( 101 )$$

Process S101-3: r_{i_rot}(kt, z) is set by rotating the scattered light vector rᵢ(kt, z) pertaining to each optical frequency, present at each optical fiber point and at the timing kt, by an angle −θ₁(kt, z). For example, the r_{i_rot}(kt, z) is calculated as follows.

$${r}_{i \_ rot} ( kt , z ) = exp [ - j {θ}_{1} ( kt , z ) ] \times {r}_{i} ( kt , z ) \qquad ( 102 )$$

Here, j is an imaginary unit.

Process S101-4: Provided that the timing kt corresponds to a first timing M(K−1) of the K-th block, a time average vector r_{i_avet}(z, K) is newly prepared, and r_{i_avet}(z, K)=r_{i_rot}(kt, z) is set. Provided that the timing kt is a second timing or a timing subsequent thereto of the K-th block, r_{i_rot}(kt, z) at the timing kt is added to the time average vector up to a timing (k−1)t, and the time average vector is updated so that a new time average vector is set. That is, the updated time average vector r_{i_avet}(z, K) is calculated as follows.

$${r}_{i \_ avet} ( z , K ) = {r}_{i \_ rot} ( kt , z ) + {r}_{i \_ avet} ( z , K ) \qquad ( 103 )$$

Process S101-5: The rotation angle αᵢ(z, K) pertaining to each optical frequency using the K-th block is calculated by using r_{i_avet}(z, K) obtained at a moment when the processing S101-4 belonging to the timing kt, corresponding to the last timing MK−1 of the K-th block, is completed. The calculation expression can be exemplified as follows.

$${α}_{i} ( z , K ) = - arg [ {r}_{i \_ avet} ( z , K ) ] \qquad ( 104 )$$

At a moment when the process S101-5 is completed, αᵢ(z, K) is transmitted to the processing unit 102.

The processing unit 102 calculates a frequency average vector, by rotating the scattered light vector rᵢ pertaining to each optical frequency fᵢ by using the rotation angle calculated by the processing unit 101 and averaging the rotated light vectors. However, unlike the technique in the related art, since the rotation angle αᵢ is updated per block spanning the time Mt, in the prior application technique, the rotation angle, used in calculating the frequency average of the scattered light vectors belonging to a certain block K, is the rotation angle calculated using the previous block K−1 by the processing unit 101. That is, detailed processing of the processing unit 102 belonging to the K-th block is as follows.

Process S102-1: A rotated vector Rᵢ(kt, z) is calculated by rotating the scattered light vector rᵢ(kt, z) pertaining to each optical frequency, present at the timing kt, by the calculated rotation angle αᵢ(z, K−1) belonging to the (K−1)-th block. The calculation method can be exemplified as follows.

$${R}_{i} ( kt , z ) = exp ( j \cdot {α}_{i} ( z , K - 1 ) ) \cdot {r}_{i} ( kt , z ) \qquad ( 105 )$$

Process S102-2: A frequency-averaged vector is calculated from the rotated vector Rᵢ(kt, z). Note that, the final result is unchanging no matter whether vector averaging or vector synthesis (simple vector sum) is performed; the vector synthesis is performed such that a frequency average vector R_{avef}(kt, z) is obtained in the actual calculation procedure. The calculation method is as follows.

$$[ Math 106 ]$$

$${R}_{avef} ( kt , z ) = {\sum }_{i = 1}^{N} {R}_{i} ( kt , z ) \qquad ( 106 )$$

Process S102-3: An angle θ_{avef}(kt, z) of the frequency average vector R_{avef}(kt, z) is calculated, and is transmitted to a subsequent signal processing unit. The calculation method is as follows.

$${θ}_{avef} ( kt , z ) = arg [ {R}_{avef} ( kt , z ) ] \qquad ( 107 )$$

Note that, in the first block of K=1, the rotation angle is not yet acquired due to no data of a previous block, and the procedure of the processing unit 102 cannot be performed. Therefore, the subsequent processing by the processing unit 102 is unperformed with measurement during the first measurement time Mt deemed to be pre-measurement. Alternatively, only the scattered light vector rᵢ(kt, z) present during the first measurement time Mt can be separately stored in the computer, and even the vibration waveform can be calculated by the technique in the related art.

The signal processing unit in the subsequent stage calculates a difference, between phases of two points separated by a gauge length, by using the obtained angular change θ_{avef}(kt, z) of the frequency average vector, performs phase connection processing and the like, and calculates a vibration waveform. As a specific calculation method, a method, similar to the method of calculating the vibration waveform from the phase in the general phase OTDR, can be used.

The key points of the prior application technique are the processing unit 101 and the processing unit 102. The processing unit 101 divides measurement data into blocks each having the number of time points M, calculates and updates a rotation angle per block spanning a measurement time Mt, and thereby copes with a temporal change in an optimum value due to a temporal change in optical characteristics such as an oscillation frequency of a laser, a temperature change of the measurement target optical fiber itself, application of a large dynamic strain to the measurement target optical fiber, and the like.

The measurement time Mt per block is set shorter than a time scale of a temporal change in optical characteristics such as an oscillation frequency of a laser, a temperature change of the measurement target optical fiber itself, or application of a large dynamic strain to the measurement target optical fiber. Thus, the rotation angle can be updated with sufficient fineness. This setting has no problem even when, as the rotation angle used by the processing unit 102 in calculating the frequency average of scattered light vectors belonging to the block K, is the rotation angle, belonging to the block K−1, calculated by the processing unit 101. In addition, by virtue of using, as the rotation angle, the rotation angle, belonging to the block K−1, calculated by the processing unit 101, the processing unit 101 does not need to keep the data of the scattered light vector rᵢ(kt, z) in the memory of the computer at a moment where r_{i_avet}(z) is updated in the process S101-3 and the process S101-4.

Here, a length of the measurement time Mt per block is also related to the calculation accuracy of the rotation angle. The measurement time Mt per block is set so long that the rotation angle can be calculated with sufficient accuracy, and is set shorter than a time scale for a temporal change in optical characteristics such as an oscillation frequency of a laser, a temperature change of the measurement target optical fiber itself, or application of a large dynamic strain to the measurement target optical fiber. Thus, the calculation accuracy of the rotation angle can also be secured. This setting is possible in many situations.

For example, obtained experimental knowledge is as follows: sufficient accuracy of the rotation angle can be obtained by setting M to approximately 100 (Non Patent Literature 3). In addition, even when a transmission period t of a pulse is set to 1 ms, Mt is approximately 100 ms. Therefore, this accuracy is fine when a time scale for a temporal change in optical characteristics such as an oscillation frequency of a laser, a temperature change of the measurement target optical fiber itself, or application of a large dynamic strain to the measurement target optical fiber is set equal to or longer than 1 s.

### Configuration Example of Measurement Device

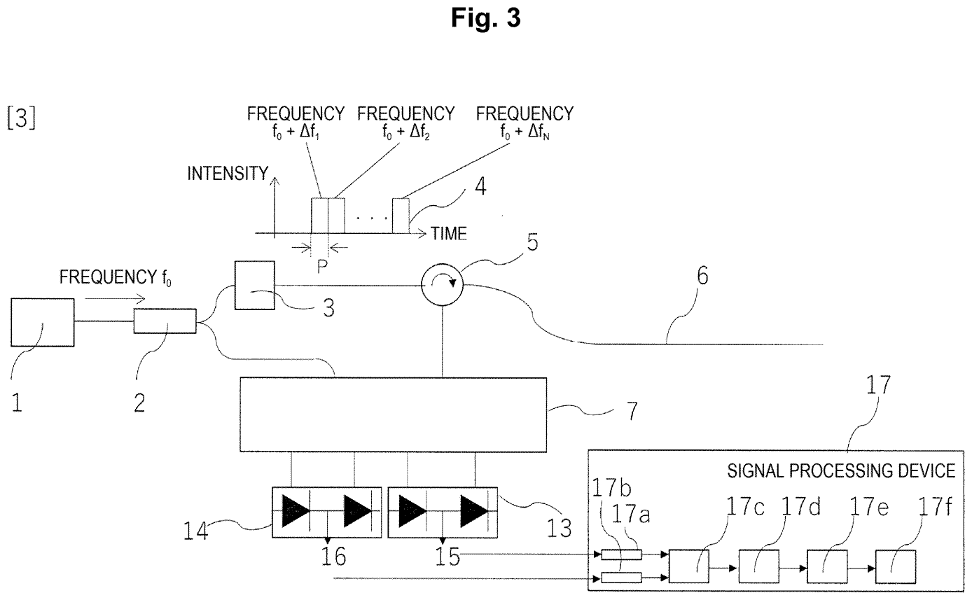

FIG. 3 illustrates a configuration example of a measurement device according to the present invention. The measurement device according to the present invention is a phase OTDR that performs processing of averaging scattered light vector signals pertaining to a plurality of optical frequencies different from each other by an optical frequency multiplexing technique. Specifically, the measurement device has configurations described below.

Continuous light having a single wavelength and a frequency f₀ is emitted from a CW light source 1, and is split into reference light and probe light by a coupler 2. The probe light is shaped into light pulses 4 by an optical modulator 3. The light pulses 4 have a configuration in which pulses are arranged by i=1, 2, . . . , N (N is an integer and represents the number of frequencies to be multiplexed), and have the frequency set to fᵢ=f₀+Δfᵢ (i is an integer) and a pulse width set to a value P corresponding to the spatial resolution of measurement in the longitudinal direction of the optical fiber. fᵢ is selected in the following manner: intensities of scattered light pertaining to different values i, preset at each timing and each optical fiber point are sufficiently separated from each other so that the intensities are deemed to be uncorrelated therebetween. The pulse width P corresponds to the spatial resolution.

As long as the light pulse 4 can be generated, the optical modulator 3 is not specifically designated with regard to types thereof, and may be a plurality of optical modulators. For example, an SSB modulator, a frequency-variable AO modulator, or the like may be used, or intensity modulation by an SOA or the like may be further performed in order to increase an extinction ratio in pulsation.

The pulsed probe light 4 enters the measurement target optical fiber 6 via a circulator 5. Here, light scattered at each point of the measurement target optical fiber 6 in the longitudinal direction returns to the circulator 5 as backscattered light, and enters one input of a 90-degree optical hybrid 7. The reference light split by the coupler 2 enters the other input of the 90-degree optical hybrid 7.

The internal configuration of the 90-degree optical hybrid may be any configuration having the function of a 90-degree optical hybrid. Among four outputs of the 90-degree optical hybrid, two outputs are detected by a balance detector 13, and an electrical signal 15, which is an analog in-phase component I^{analog}, is acquired. The remaining two outputs of the 90-degree optical hybrid are detected by a balance detector 14, and an electrical signal 16, which is an analog quadrature component Q^{analog}, is acquired.

The electrical signal 15 and the electrical signal 16 are transmitted to a signal processing device 17 that includes an AD conversion function element 17a and an AD conversion function element 17b capable of sampling frequency bands of signals without aliasing. In the signal processing device 17, the digitized signals, including the in-phase component I^{digital} and the quadrature component Q^{digital}, output from the AD conversion function element 17a and the AD conversion function element 17b are separated by a signal processing unit 17c into signals Iᵢ and Qᵢ deriving from the scattered light caused by pulses, having different frequencies fᵢ (i=1, 2, . . . , N), included in the light pulse 4.

There is no specific restriction on the signal processing method for the separation. For example, the method conceivably guarantees a phase delay by allowing I^{digital} and Q^{digital} to pass through a digital band pass filter having a center frequency that is set to Afi and a pass band that is set to 2/P. When a filter characteristic of a digital band-pass filter is set to a specification, capable of streaming measurement data, in consideration of a memory size or the like of a calculator in use, the measurement data is streamed up to the signal processing unit 17c.

### (Configuration of Signal Processing Device)

A signal processing unit 17d, a signal processing unit 17e, and a signal processing unit 17f continuously perform phase calculation. The signal processing unit 17d, the signal processing unit 17e, and the signal processing unit 17f function as functional units included in the signal processing device according to the present disclosure, and a role of each of the signal processing units is as follows. An injection interval of pulses, that is, a sampling rate of vibration is set to t, and vibration data is acquired at a timing kt using an integer k. Further, a distance from an injection end is set to z.

Signal processing unit 17d: The signal processing unit 17d functions as a functional unit that calculates a correction value for a phase offset between different optical frequencies per measurement data within a range of a time window having a predetermined window length Mt.

The functional unit acquires measurement data of scattered light deriving from a plurality of light pulses having different optical frequencies, which are scattered in an optical fiber, calculates scattered light vectors rᵢ of the scattered light pertaining to each optical frequency within the time window having the predetermined window length, performs averaging the scattered light vectors rᵢ pertaining to the optical frequencies included in the time window, and calculates a rotation angle αᵢ for correcting a phase pertaining to each optical frequency by using a time average vector r_{i_avet} obtained by the averaging.

Hereinafter, details will be described.

The signal processing unit 17d calculates the scattered light vector rᵢ(kt, z) from Iᵢ(kt, z) and Qᵢ(kt, z), and continuously streams data of the calculated scattered light vector rᵢ(kt, z) to the signal processing unit 17e.

Further, the signal processing unit 17d calculates a rotation angle αᵢ(kt, z) pertaining to each optical frequency fᵢ used for frequency averaging at the timing kt, by using the scattered light vectors present at timings from (k−W)t to (k+W) t. That is, the window length Mt satisfies Mt=(2W+1)t. With regard to “W”, any value corresponding to the setting of the window length Mt can be adopted. The method of setting the window length Mt will be described later. The calculated rotation angle αᵢ(kt, z) is continuously streamed to the signal processing unit 17d.

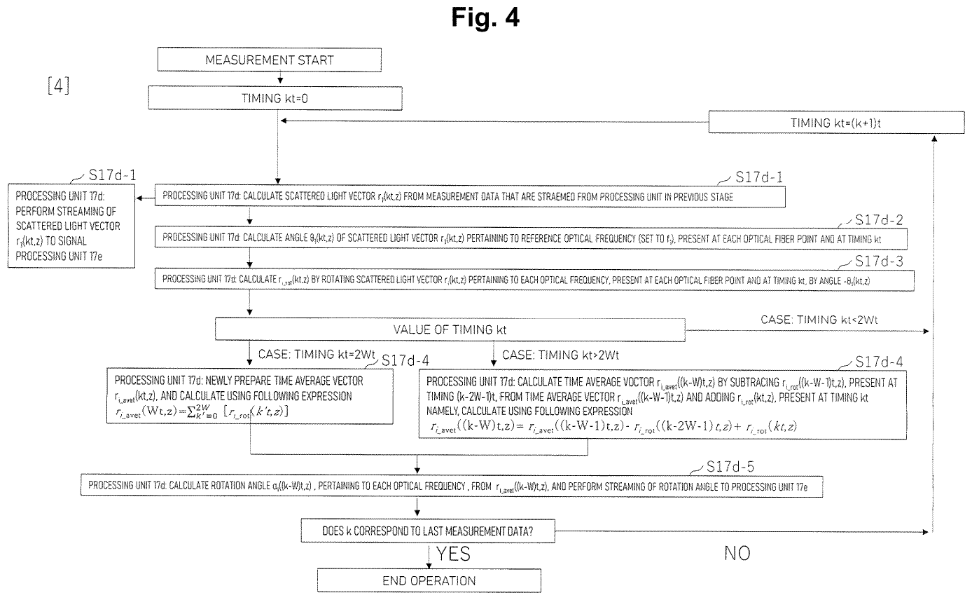

An implementation example of the calculation procedure will be described below. The example premises that the measurement is started from k=0. Since the signal processing unit 17d is a key point of the present embodiment, a flowchart is also illustrated in FIG. 4.

Procedure S17d-1: The scattered light vector rᵢ(kt, z) is calculated from Iᵢ(kt, z) and Qᵢ(kt, z) present at the timing kt. For example, given that the imaginary unit is set to j, the scattered light vector rᵢ(kt, z) is calculated as follows.

$${r}_{i} ( kt , z ) = {I}_{i} ( kt , z ) + j \cdot {Q}_{i} ( kt , z ) \qquad ( d1 )$$

Data of the calculated scattered light vector is sequentially streamed to the processing unit 17e.

Procedure S17d-2: The reference frequency is set to f₁. Here, the reference frequency can be freely selected, and thus the reference frequency may not be f₁. An angle θ₁(kt, z) of a scattered light vector r₁(kt, z) pertaining to the reference optical frequency, present at each optical fiber point and at a timing kt is calculated. For example, the angle θ₁(kt, z) can be calculated as follows.

$${θ}_{1} ( kt , z ) = arg [ {r}_{1} ( kt , z ) ] \qquad ( d2 )$$

Procedure S17d-3: r_{i_rot}(kt, z) is set by rotating the scattered light vector rᵢ(kt, z) pertaining to each optical frequency, present at each optical fiber point and at the timing kt by an angle −θ₁(kt, z). For example, r_{i_rot}(kt, z) can be calculated as follows.

$${r}_{i \_ rot} ( kt , z ) = exp [ - j {θ}_{1} ( kt , z ) ] \times {r}_{i} ( kt , z ) \qquad ( d3 )$$

Procedure S17d-4: The time average vector r_{i_avet}((k−W)t, z) is calculated using the time average vector r_{i_avet}((k−1−W)t, z) calculated from the data pertaining to timings from (k−2W−1)t to (k−1)t, r_{i_rot}((k−2W−1)t, z) present at a timing (k−2W−1)t, and r_{i_rot}(kt, z) present at a timing kt. The calculation expression can be exemplified as follows.

$${r}_{i \_ avet} ( ( k - W ) t , z ) = {r}_{i \_ avet} ( ( k - W - 1 ) t , z ) - {r}_{i \_ rot} ( ( k - 2 W - 1 ) t , z ) + {r}_{i \_ rot} ( kt , z ) \qquad ( d4 - 1 )$$

Here, since measurement is performed from k=0 to k=2W, the window length to which obtained data pertains is equal to or longer than (2W+1) t. Thus, in regard to case k=2W, the time average vector is obtained as addition of r_{i_rot}(kt, z) up to k≤2W. The calculation expression can be exemplified as follows.

$$[ Math . d 4 - 2 ]$$

$${r}_{i \_ avet} ( Wt , z ) = {\sum }_{{k}^{′} = 0}^{2 W} {r}_{i \_ rot} ( {k}^{′} t , z ) \qquad ( d4 - 2 )$$

With respect to the data belonging to a timing k<2W, preliminary measurement is performed, or a time average vector is calculated using the technique in the related art. When the technique in the related art is used, the time average vector belonging to any timing k<2W can be uniformized to turn into the time average vector belonging to a timing k=2W. That is, the following equation is established.

$${r}_{i \_ avet} ( kt , z ) = {r}_{i \_ avet} ( Wt , z ) \qquad ( d4 - 3 )$$

Procedure S17d-5: The rotation angle αᵢ((k−W)t, z) is calculated using the argument of the calculated time average vector r_{i_avet}((k−W)t, z). The calculation expression can be exemplified as follows.

$${α}_{i} ( ( k - W ) t , z ) = - arg [ {r}_{i \_ avet} ( ( k - W ) t , z ) ] \qquad ( d5 )$$

The calculated rotation angle αᵢ((k−W)t, z) is sequentially streamed to the signal processing unit 17e.

Signal processing unit 17e: The signal processing unit 17e functions as a functional unit that executes correction for the phase offset between the different optical frequencies by performing processing of averaging measurement data, belonging to a middle of the time window and a timing later than the middle, by using the correction value obtained by the signal processing unit 17d with the time window kept moving in a time direction.

The functional unit corrects the phase offset between the different optical frequencies by rotating a phase of a scattered light vector rᵢ pertaining to each optical frequency by the rotation angle αᵢ and calculating a frequency-averaged vector from each rotated vector Rᵢ belonging to the middle and the timing later than the middle of the time window.

Hereinafter, details will be described.

The signal processing unit 17e calculates a frequency-averaged vector by rotating the scattered light vector rᵢ pertaining to each optical frequency fᵢ, by using the rotation angle calculated by the signal processing unit 17d and averaging the rotated light vector. Similarly to the prior application technique, unlike the technique in the related art, the rotation angle is inconstant, and is a value streamed from the signal processing unit 15d, updated in the lapse of time, and temporally used. Here, unlike the prior application technique, in which the different values belong to the respective blocks, a value that differs depending on the timing is used. An implementation example of the calculation procedure will be described below.

Procedure S17e-1: A rotated vector Rᵢ(kt, z) is calculated by rotating the scattered light vector rᵢ(kt, z), which is streamed from the signal processing unit 17d in the procedure S17d-1, by the rotation angle αᵢ(kt, z), which is streamed from the signal processing unit 17d in procedure S17d-5. The calculation method can be exemplified as follows.

$${R}_{i} ( kt , z ) = exp ( j \cdot {α}_{i} ( kt , z ) ) \cdot {r}_{i} ( kt , z ) \qquad ( e1 )$$

Procedure S17e-2: A frequency-averaged vector, obtained from the rotated vector Rᵢ(kt, z), is calculated. Note that, the final result is unchanging no matter whether vector averaging or vector synthesis (simple vector sum) is performed; the vector synthesis is performed such that a frequency average vector R_{avef}(kt, z) is obtained in the actual calculation procedure. The calculation method can be exemplified as follows.

$$[ Math . e2 ]$$

$${R}_{avef} ( kt , z ) = {\sum }_{i = 1}^{N} {R}_{i} ( kt , z ) \qquad ( e2 )$$

Procedure S17e-3: An argument θ_{avef}(kt, z) of the frequency average vector R_{avef}(kt, z) is calculated, and is transmitted to the signal processing unit 17f. The calculation method can be exemplified as follows.

$${θ}_{avef} ( kt , z ) = arg [ {R}_{avef} ( kt , z ) ] \qquad ( e3 )$$

Signal processing unit 17f:

The signal processing unit 17f calculates a vibration waveform by calculating a difference, between phases of two points separated by a gauge length, by using the angular change θ_{avef}(kz, t) of the frequency average vector, which is obtained by the signal processing unit 17e, and performing phase connection processing and the like. As a specific calculation method, a method similar to the method of calculating the vibration waveform from the phase in the general phase OTDR can be used.

In the present embodiment, when a memory capacity of the signal processing unit can hold required information such as all the scattered light vectors included in the window length Mt, streaming processing can be performed. Even when the memory capacity cannot hold required information, the same result can be finally obtained by performing offline processing of all or some of the procedures.

In the above procedures, the signal processing unit 17d streams the rotation angle αᵢ((k−W)t, z) calculated using measurement data belonging to timings from (k−2W)t to kt to the signal processing unit 17e, and the signal processing unit 17e performs frequency averaging pertaining to a timing (k−W)t. Therefore, the signal processing unit 17e needs to hold data belonging to timings from (k−W)t to kt. For this reason, when the data on the memory is not sharable between the signal processing unit 17d and the signal processing unit 17e, the memory holding amount of the signal processing unit 17e increases. As a countermeasure, the rotation angle αᵢ((k−W)t, z) can also be used for the frequency average pertaining to a timing (k−W+Delay)t later than the timing (k−W)t (the variable Delay is set to an integer reflecting a delay amount). That is, the rotation angle calculated using the measurement data within the range of the time window having a window length 2W+1 can be used for the frequency average pertaining to timings later than the middle timing of the time window. As the temporal difference amount Delay increases, a difference, between the optimum rotation angle αᵢ((k−W+Delay)t, z) present at a timing (k−W+Delay)t and the rotation angle αᵢ((k−W)t, z) to be used, also increases. Therefore, an extent to which the timing is set later than the middle (an extent to which Delay is set large) preferably keeps a minimum value determined on the basis of the memory capacity or the like.

A method of setting the window length Mt=(2W+1)t will be described. The window length Mt is set to be shorter than a time scale for a temporal change in optical characteristics such as an oscillation frequency of a laser, a temperature change of the measurement target optical fiber itself, or application of a large dynamic strain to the measurement target optical fiber. Thus, the optimal rotation angle can be updated with sufficient accuracy.

Here, since the length of the window length Mt is also related to the calculation accuracy of the rotation angle, the length needs to be so long that the rotation angle can be calculated with sufficient accuracy. This setting is possible in many situations. For example, obtained experimental knowledge is as follows: sufficient accuracy of the rotation angle can be obtained by setting M to approximately 100 (Non Patent Literature 3). In addition, even when a transmission period t of a pulse is set to 1 ms, Mt is approximately 100 ms. Therefore, this accuracy is fine when a time scale for a temporal change in optical characteristics such as an oscillation frequency of a laser, a temperature change of the measurement target optical fiber itself, or application of a large dynamic strain to the measurement target optical fiber is set to be equal to or longer than 1 s.

In the present invention, movement average processing is performed in the procedure of calculating the rotation angle: the movement average processing is not performed on the final signal. Therefore, a feature of the present invention is advantageous because a problem of removal of a high frequency component of the final signal is less likely to occur. Thereby, the present invention can also be used for application for measuring even high frequency components.

The signal processing device according to the present disclosure can also be implemented by a computer and a program, and the program can be provided by being recorded on a recording medium or through a network. A program according to the present disclosure is a program for implementing a computer as each functional unit included in the device according to the present disclosure, and is a program for directing a computer to execute each step included in a method performed by the device according to the present disclosure.

### REFERENCE SIGNS LIST

1 CW light source
2 Coupler
3 Optical modulator
4 Light pulse
5 Circulator
6 Measurement target optical fiber
7 90-degree optical hybrid
13, 14 Balance detector
15, 16 Electrical signal
17 Signal processing device
17a, 17b AD conversion function element
17c, 17d Signal processing unit
31 Measurement device

1. A signal processing device as a phase OTDR that performs processing of averaging scattered light vector signals pertaining to a plurality of optical frequencies different from each other, by an optical frequency multiplexing technique, the signal processing device comprising:
a functional unit that calculates a correction value for a phase offset between different optical frequencies per measurement data within a range of a time window having a predetermined window length; and
a functional unit that executes correction for the phase offset between the different optical frequencies by performing processing of averaging measurement data, belonging to a middle of the time window and a timing later than the middle, by using the correction value with the time window kept moving in a time direction.

2. The signal processing device according to claim 1,
wherein the functional unit that calculates the correction value is configured to:
acquire measurement data of scattered light deriving from a plurality of light pulses having different optical frequencies, which are scattered in an optical fiber;
calculate scattered light vectors rᵢ of the scattered light pertaining to each optical frequency within the time window having the predetermined window length;
perform averaging of the scattered light vectors rᵢ pertaining to the optical frequencies included in the time window; and
calculate a rotation angle αᵢ for correcting a phase pertaining to each optical frequency by using a time average vector r_{i_avet} obtained by the averaging, and the functional unit that performs the correction is configured to correct the phase offset between the different optical frequencies by rotating a phase of a scattered light vector rᵢ pertaining to each optical frequency by a rotation angle αᵢ and calculating a frequency-averaged vector from each rotated vector Rᵢ belonging to the middle of the time window and the timing later than middle.

3. A signal processing method for a phase OTDR that performs processing of averaging scattered light vector signals pertaining to a plurality of optical frequencies different from each other, by an optical frequency multiplexing technique, the signal processing method comprising:
a procedure of calculating a correction value for a phase offset between different optical frequencies per measurement data within a range of a time window having a predetermined window length; and
a procedure of executing correction for the phase offset between the different optical frequencies by performing processing of averaging measurement data, belonging to a middle of the time window and a timing later than the middle, by using the correction value with the time window kept moving in a time direction.

4. A non-transitory storage medium containing a program for directing a computer to function as each functional unit included in the signal processing device according to claim 1.
